(19) United States
(12) Patent Application Publication
(10) Pub. No.: US 2017/0210594 A1
(43) Pub. Date: Jul. 27, 2017

(54) METHOD FOR CONTROLLING A LIFT INSTALLATION

(71) Applicants: ThyssenKrupp Elevator AG, Essen (DE); ThyssenKrupp AG, Essen (DE)

(72) Inventors: Stefan Gerstenmeyer, Filderstadt (DE); Stefan Schneider, Filderstadt (DE)

(73) Assignees: ThyssenKrupp Elevator AG, Essen (DE); ThyssenKrupp AG, Essen (DE)

(21) Appl. No.: 15/328,614

(22) PCT Filed: Jul. 23, 2015
(86) PCT No.: PCT/EP2015/066852

§ 371 Date: Jan. 24, 2017

(30) Foreign Application Priority Data
Jul. 24, 2014 (DE) 10 2014 214 587.2

(51) Int. Cl. B66B 1/24; B66B 1/46

(52) U.S. Cl. CPC B66B 1/2458; B66B 1/468; B66B 2201/402; B66B 2201/243; B66B 2201/4661; B66B 2201/4669; B66B 2201/103; B66B 2201/301; B66B 2201/4676

(57) ABSTRACT

A method for controlling a lift installation having a plurality of cabins that can each stop at a number of floors may involve assigning calls placed outside the cabins to the cabins by way of a lift controller based on at least one assignment criterion. The method may involve considering a current traffic situation of the lift installation during the assignment. The method may further involve generating and considering a forecast of a future traffic situation of the lift installation during the assignment. The forecast may account for personal information of at least one of a person who is in a predetermined environment of the lift installation, a person who is in a section of the lift installation, a person who enters a predetermined environment of the lift installation, or a person who leaves a predetermined environment of the lift installation.”

The present invention relates to a method for controlling a lift installation according to the precharacterizing clause of patent claim 1.

Numerous methods and procedures are known for the purpose of increasing the conveying capacity of lift systems comprising a number of lift cars or cabins which serve a plurality of floors.

In this case, for example, empirically determined traffic loads which are dependent on the time of day or the day of the week, for example, can be taken into account when allocating cabins of a lift system.

Destination selection or destination call controllers, for example, are known for the purpose of increasing the conveying capacity. In the case of these controllers, a user on an entrance floor inputs a call to the lift controller with regard to the destination floor to which the user would like to be conveyed (so-called destination call). Such a destination call system is considerably more powerful than conventional cabin call systems in which a destination floor is input by a user only in a cabin.

The disadvantage in this case is considered to be the fact that only information empirically derived from the past with respect to traffic volume enters such a controller.

The invention is based on the object of further increasing the conveying capacity of lift installations.

This object is achieved by means of a method having the features of patent claim 1 and a corresponding system having the features of patent claim 11.

By virtue of the fact that personal information relating to persons who have not yet made a call but are in a predetermined environment of the lift system or a section of the lift system is taken into account according to the invention, it is possible to generate a prediction or forecast of an expected traffic volume (in particular in the short term) for the lift system in a manner which is significantly improved in comparison with conventional solutions.

Personal information can be understood as meaning, in particular, pure presence information relating to persons (that is to say without individualized recognition of particular persons). Taking into account such presence information already makes it possible, according to the invention, to create durable forecasts of a future traffic situation of a lift installation. However, alternatively or additionally, the term personal information is also intended to include individualized personal information, in the case of which an identity or characteristic of a detected person can also be determined and can therefore be taken into account in the forecast carried out according to the invention. Taking into account such personal information comprising data relating to individual persons makes it possible to create yet more accurate and more reliable forecasts for future traffic situations of the lift installation. For example, if a particular person is recognized, a potential or likely destination of this person can also be taken into account as part of the forecast. It is also possible, for example, for a plurality of typical destinations of this person to also be assigned to such individual personal information and to be able to be taken into account in a forecast. In this case, the lift system is able to forecast journey sequences and to accordingly make cabins available.

Information which is obtained from external systems (with respect to the actual lift installation) and can be transmitted to the lift controller is referred to as personal information, in particular. In this case, the transmission can be conventionally carried out in a wired or wireless manner. Such external systems expediently comprise devices which are provided in the same building as the lift installation. However, it is also already possible to detect persons or motor vehicles approaching the building, for example. It is conceivable, for example, to monitor approaches of potential users of the lift installation in a radius of several hundred meters or else several kilometers and to provide the lift controller with corresponding information. It is also conceivable, for example, to use data obtained from a navigation system of a vehicle in this manner.

The method according to the invention is particularly suitable for use in connection with a destination call controller. Destination calls can be processed more efficiently with such an improved prediction.

The method according to the invention can be used in a particularly advantageous manner in connection with lift systems which use zone division of the floors of a building in connection with a transfer floor control function. If a cross-zone destination call from a first zone to a second zone is made in such a system, the user/passenger must change on a transfer floor. As a result, two destination calls must be generated, namely a first call from the entrance floor of the user to the transfer floor and then a second destination call from the transfer floor to the destination floor of the user. The second destination call can be generated automatically by the controller, for example shortly before the transfer floor is reached, or after the transfer floor has been reached. It is also possible for the user to be requested again to input his destination floor after the transfer floor has been reached. Such destination calls can also be considered to be personal information relating to persons in the sense of the invention. For example, a first destination call (from the entrance floor to the transfer floor) derived from a cross-zone destination call can be interpreted and processed as personal information for the second zone.

According to one particularly preferred embodiment of the method according to the invention, personal information is obtained by means of at least one separation installation situated in the environment of the lift device. A building or high-rise building in which the lift installation is installed can be considered to be the environment of the lift device, in particular. Such a building may comprise an underground garage, for example. Personnel locks, in particular turnstiles, may be mentioned, in particular, as separation installations. In connection with an underground garage, a barrier installation for vehicles can also be considered to be a separation installation, for example.

Alternatively or additionally, personal information can be expediently obtained by means of at least one person recognition device. Simple infrared barriers or else scanning apparatuses, for example with facial recognition or gesture recognition, or card readers may be mentioned, for example, as person recognition devices. In this context, it is also conceivable to use, for example, the unlocking or locking of an office or another room by actuating a lock device as personal information in the sense of the present invention.

The personal information obtained is advantageously taken into account when forecasting a future traffic volume in a form weighted according to empirically determined or predefined probabilities.

After being acquired, the personal information is expediently taken into account over respectively predetermined periods, in which case such a period can be correlated with a time-dependent probability, for example.

These measures make it possible to ensure, for example, that personal information obtained in the immediate vicinity of a lift installation, in particular in the immediate vicinity of a landing door, is taken into account with a stronger weighting for the forecast since the probability is high here of an item of presence information acquired in this manner actually resulting in a destination call being input within a relatively short period. If, in contrast, the entry of a vehicle (by means of a barrier installation) into an underground garage of building is detected, for example, an accordingly lower probability of this resulting in a destination call can be set, for example. On the other hand, an accordingly lower probability can be taken into account over a longer period in this case since it typically takes a few minutes for a vehicle occupant to park his vehicle in the underground garage, lock the vehicle and arrive at a lift where he can then place a destination call.

Such periods can also be correlated with time-dependent probability curves, for example bell-shaped curves. If it is assumed, for example, that a vehicle occupant has placed a destination call at the latest within 10 minutes after entering an underground garage (after this period, it can be assumed that the vehicle occupant remains in the underground garage or leaves the latter again), a probability maximum can be set at approximately five minutes from entering the underground garage.

The described examples for probabilities and their correlation with periods are used only for illustration.

The forecast is advantageously created taking into account personal information obtained using personal identification means. RFID tags or facial recognition apparatuses, for example, can be used as personal identification means.

The lift controller is expediently designed to move at least one cabin to a predetermined floor and/or to park it on a predetermined floor on the basis of a created forecast. Advantageous uses of this stipulation are, for example, that a cabin can be moved in good time to a suitable floor and/or can be parked there if a particular person is recognized, for example a doctor on call. This measure also makes it possible to minimize empty journeys.

The invention is now described further using the accompanying drawing, in which:

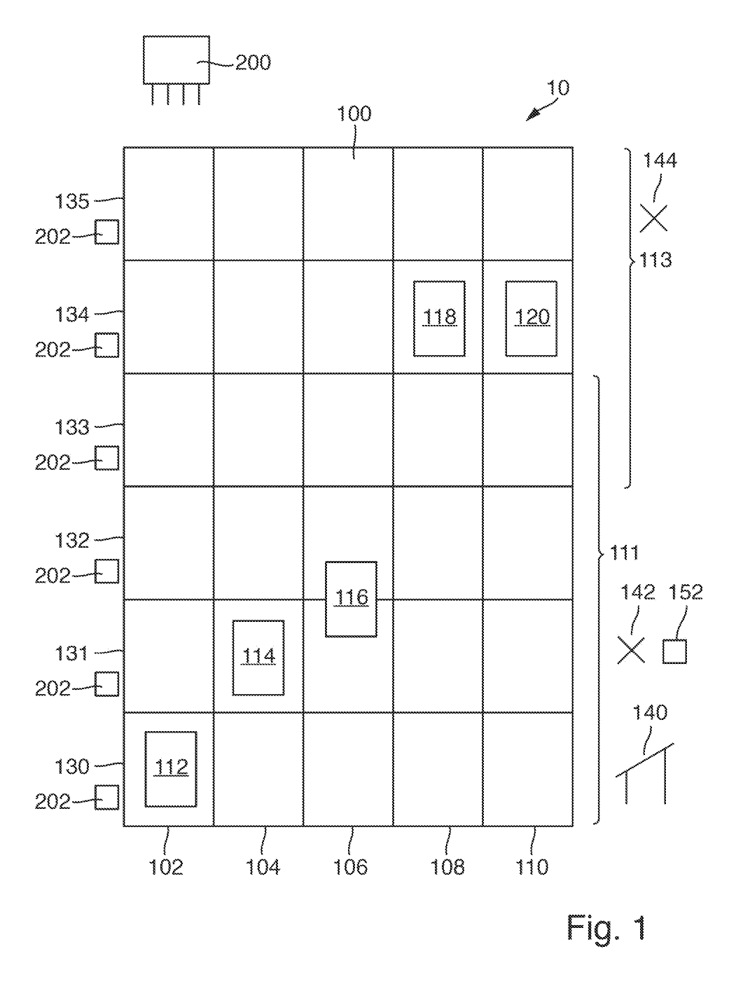

FIG. 1 shows a schematic diagram of a lift system installed in a building for explaining one preferred embodiment of the method according to the invention.

A lift installation 100 is installed in a building 10.

The lift installation 100 comprises a total of five lift shafts 102 to 110 in each of which a lift car 112 to 120 can be moved. The drives of the individual lift cars 112 to 120 (for example traction sheave drives) are not illustrated in detail.

It is noted that a plurality of lift cars which can be moved independently of one another can also be provided in the lift shafts 102 to 110.

The building 10 comprises a number n of floors. For the sake of simplicity, six floors are illustrated. In practice, considerably higher numbers of floors can be assumed. The floors are subdivided into two zones 111 and 113 which overlap on floor 133. It is noted that this overlapping region may also comprise a plurality of floors. The lift cars 112, 114, 116 can be moved inside the first zone 111, and the lift cars 118, 120 can be moved in the second zone 113.

The lift installation 100 comprises a lift controller 200 which is designed to carry out zone-based destination call control. The lift controller 200 is connected to input and display apparatuses, for example touchscreens 202, which are provided on each floor. A user or passenger can use the input and display apparatuses 202 to input a destination call on the floors. In response to such a destination call, the user receives the indication of which of the lift cars 112 to 120 he should use. If the user places a cross-zone call, for example from floor 131 to floor 135, the apparatus 202 is used to indicate to the user which lift car 112 to 116 he should use to reach the transfer floor 133. At the same time (or else subsequently in the lift car), the user is informed that, shortly before reaching the transfer floor or after reaching the transfer floor 133, he will be informed of which lift car 118 to 120 he should use from the transfer floor 130 to his destination floor 135.

For example, it is assumed that the floor 130 is an underground garage floor. Floor 131 is an entrance or lobby floor, and floor 135 is a canteen floor. The other floors 132 to 134 are pure office floors.

A barrier 140 is provided at the entrance to the underground garage on floor 130. A turnstile 142 is provided as a separation device at the entrance to the entrance floor 131. A further turnstile 144 is provided on the floor 135 between a canteen area and the lift installation 100.

At a particular time t₀, the lift cars 112 to 120 are in the respective positions illustrated by way of example on or between floors. It is assumed that destination calls have already been input to the respective apparatuses 202 on some floors and the lift controller 200 has accordingly assigned lift cars.

If a vehicle now arrives at the underground garage and passes through (with appropriate authorization or confirmation) the barrier 140, this information is made available to the lift controller 200 as (personal information relating to) a person. If, for example, the specific number of vehicle occupants in the vehicle is not determined, the lift controller can assume an average vehicle occupancy of 1.4 occupants, for example. With an empirically known probability (for example of 0.8), for example, this event results in a destination call being input on the floor 130. In this case, it is likewise (empirically) known that a maximum of 10 minutes, for example, elapse between the actuation of the barrier 140 and the placing of such a destination call, the greatest probability being in a period of approximately 3-5 minutes after actuation of the barrier. On the basis of this personal information as a result of actuation of the barrier 140 and the probabilities or probability distributions accordingly linked thereto, the lift controller 200 is able to calculate a modified forecast for a lift load to be expected in the short term.

If, as a further example, a person enters floor 131 through the turnstile 142, this can likewise be considered to be personal information (and therefore a potential use of the lift installation) according to the invention. In this case, it is assumed, for example, likewise on an empirical basis, that a particular probability (for example 0.7) exists of a person wishing to use the lift installation and placing a destination call after actuation of the turnstile 142. In this case too, it is possible to set an empirically determined period with a corresponding probability distribution, in which case this period will generally be shorter than the period set for the underground garage, that is to say a maximum of one to two minutes, for example. On the basis of this personal information as well, the lift controller 200 is able to create or modify a forecast for a future lift load.

It is also possible to use person recognition devices. For example, a facial recognition device may be provided, as an alternative or in addition to the turnstile 142, as a person recognition device 152 on floor 131.

Corresponding information can also be derived upon actuation of the turnstile 144 on the floor 135.

The transfer floor control function which was explained above and uses two partial destination calls can also be used, in the sense of personal information, to further modify such a forecast. For example, in the case of a comprehensive destination call, it can be assumed with great probability (for example 0.9) that the (second) partial destination call will be made by the user on the transfer floor 133 within a short period of time, for example within the next 30 seconds.

The personal information obtained in this manner and the modified forecasts derived from said information are expediently linked to empirical usage data relating to the lift installation, for example according to the day of the week or the time of day.

A transfer floor transmission function can also be designed in such a manner that a user is informed from the outset that he can only reach the transfer floor 133 with a first destination call and must place a further destination call there. These partial destination calls can also be used as personal information in the sense of the invention.

On the basis of forecasts modified using such personal information, a future load or traffic situation of the lift installation can be predicted with greater accuracy. Overall, the conveying capacity of the system can be increased hereby since individual cabins can be moved, parked and provided in a more targeted manner, for example. Unnecessary empty journeys can be prevented, as a result of which the energy requirement of the lift installation also decreases.

In a further embodiment of the method according to the invention, personal identification means can also be used to provide individualized personal information. If, for example, it is detected which person is passing through at the barrier 140 or at one of the turnstiles 142, 144, it is possible to generate an item of improved personal information which takes into account which specific floor an expected destination call will be meant for and with what probability (person x has his office on floor 134 and will place a corresponding destination call with a very high probability). Such person recognition can be achieved, for example, by means of RFID tags or facial recognition. A forecast of future loads of the lift system which is refined further is possible using such information.

As explained, it is assumed that the floors 132 to 134 are office floors. In this case, it is possible, for example, to transmit a corresponding item of information to the lift controller 200 as personal information when an office door is locked by a person. This also makes it possible to refine a forecast for future loads of the lift system.

Overall, in order to identify potential passengers of the lift system, it is possible to use systems which require particular apparatuses or equipment to be touched, or else contactless systems. Systems which identify potential passengers using artificial intelligence and provide the necessary information are also conceivable. Information which is included in the forecast is, in particular, an entrance or arrival floor, a destination floor, a time of arrival at the lifts and possibly special needs of a passenger (for example for the optimum use of an accessible cabin). Detailed information relating to groups of passengers may also be acquired and transmitted to the lift controller 200. It is additionally possible, when the passenger has arrived at the lift cars or the apparatuses 202, for a destination call to be automatically made with the aid of suitable personal identification means. The assignment can then be communicated to the passenger using the apparatuses 202 provided or personalized display devices (for example a smartphone which is carried along).

1.-11. (canceled)

12. A method for controlling a lift installation comprising cabins that can each stop at a number of floors, the method comprising assigning calls placed outside the cabins to the cabins by way of a lift controller based on at least one assignment criterion, wherein the assigning comprises:
considering a current traffic situation of the lift installation;
obtaining personal information of at least one of a person who is in a predetermined environment of the lift installation, a person who is in a section of the lift installation, a person who enters the predetermined environment of the lift installation, or a person who leaves the predetermined environment of the lift installation, wherein the personal information is obtained by at least one separation device in the predetermined environment of the lift installation, with the at least one separation device comprising at least one of a personnel lock or a barrier installation; and
generating and considering a forecast of a future traffic situation of the lift installation based on the personal information.

13. The method of claim 12 wherein the personal information is presence information.

14. The method of claim 12 wherein the lift controller performs destination call control.

15. The method of claim 12 wherein the number of floors are subdivided into partially overlapping zones, wherein the lift controller is configured to perform a transfer floor control function, with cross-zone destination calls being processed as at least two partial destination calls, wherein the personal information is obtained on a basis of at least one partial destination call.

16. The method of claim 12 further comprising obtaining the personal information by way of at least one person recognition device.

17. The method of claim 16 wherein the at least one person recognition device comprises an infrared barrier, a facial recognition device, a gesture recognition device, a lock device, or a machine to be operated.

18. The method of claim 12 further comprising considering the personal information in a form weighted according to predetermined or predefined probabilities.

19. The method of claim 12 further comprising considering the personal information over predeterminable periods.

20. The method of claim 12 wherein the forecast is generated based on personal identification data obtained using the personal information.

21. The method of claim 12 further comprising moving at least one of the cabins to a predetermined floor and/or parking the at least one of the cabins on the predetermined floor based on the forecast.

22. A system for controlling a lift installation comprising:
a separation device;
cabins that can each stop at a number of floors; and
a lift controller that assigns calls placed outside the cabins to the cabins based on at least one assignment criterion, wherein the lift controller assigns cabins based on a current traffic situation of the lift installation and based on a forecast of a future traffic situation of the lift installation, the forecast based at least on personal information of at least one of a person who is in a predetermined environment of the lift installation, a person who is in a section of the lift installation, a person who enters the predetermined environment of the lift installation, or a person who leaves the predetermined environment of the lift installation, wherein the personal information is obtained by the separation device in the predetermined environment of the lift installation.

23. The system of claim 22 wherein the separation device comprises at least one of a personnel lock or a barrier installation.

24. A method for controlling a lift installation comprising cabins that can each stop at a number of floors, the method comprising assigning calls placed outside the cabins to the cabins, wherein assigning the calls comprises:
considering a current traffic situation of the lift installation;
obtaining by way of a separation device in a first predetermined environment of the lift installation personal information of at least one of a person who is in a second predetermined environment of the lift installation, a person who is in a section of the lift installation, a person who enters a third predetermined environment of the lift installation, or a person who leaves a fourth predetermined environment of the lift installation; and
generating and considering a forecast of a future traffic situation of the lift installation based on the personal information obtained from the separation device.

25. The method of claim 24 wherein the separation device comprises at least one of a personnel lock or a barrier installation.

26. The method of claim 24 wherein the first, second, third, and fourth predetermined environments are coterminous.
